(19) United States
(12) Patent Application Publication
(10) Pub. No.: US 2009/0016806 A1
(43) Pub. Date: Jan. 15, 2009

(54) DISPLAY SYSTEM

(75) Inventors: Lars Wolf, Gaggenau (DE); Gerhard Bisch, Gaggenau (DE)

Correspondence Address: SEED INTELLECTUAL PROPERTY LAW GROUP PLLC, 701 FIFTH AVE, SUITE 5400, SEATTLE, WA, 98104, US

(73) Assignee: G-LEC EUROPE GmbH, Oetigheim (DE)

(21) Appl. No.: 12/065,606

(22) PCT Filed: Sep. 2, 2005
(86) PCT No.: PCT/EP2005/009457

§ 371 Date: Sep. 10, 2008

(51) Int. Cl. G09F 9/33; G09G 5/00

(52) U.S. Cl. 403/24; 345/1.1

(57) ABSTRACT

The present invention relates to a display system having a large number of display panels. Each display panel comprises a large number of light-emitting elements. The display system further includes a system control for actuating the display panels and a data bus which connects the system control to each of the display panels.

The present invention relates to a display system having a large number of light-emitting elements. The display system is adapted to provide a predetermined representation, in particular on a screen, by the light emission of the light-emitting elements being suitably controlled.

### STATE OF THE ART

The present invention is based on the display system disclosed in patent application EP 1 293 955 A2. EP 1 293 955 A2 discloses a display arrangement comprising a holding element and a large number of light-emitting elements fixed to the holding element. The arrangement is adapted to represent desired representations in a screen-like fashion, by the light emission of the light-emitting elements being suitably controlled. The display arrangement includes a display panel of light-emitting elements. The display panel has a holding frame and a large number of bars with light-emitting elements which are arranged parallel and at a uniform spacing relative to each other. The bars are secured to the holding frame. Each bar is enclosed by a cylindrical translucent tube.

The display arrangement of EP 1 293 955 A2 additionally includes a light emission control means including a computer which is adapted to control the light emission of the large number of bars with light-emitting elements in the display panel. The bar of the display arrangement in the state of the art includes in particular a cylindrical translucent tube and a display module arranged in the translucent tube. The display module includes an elongate structural assembly and light-emitting elements in the form of a large number of pixels arranged along a line in the longitudinal direction of the elongate circuitry structural assembly. Each pixel includes LEDs of the three primary colors red (R), blue (B) and green (G) and a circuit for control of the light emission, which is connected to the pixels.

In particular it is provided that a large number of light-emitting display panels is connected to the arrangement to be provided. The light-emitting display panels are arranged in accordance with a predetermined pattern in the vertical and horizontal directions. In addition they are fixed flexibly to each other. The pixels in the display modules are arranged in the form of a matrix in the light-emitting display panels. The control circuit actuates the individual pixels in the matrix and controls the light emission thereof, thereby producing a color image.

A control system for actuation of the display panels is provided in conventional fashion. The control system usually includes a control comprising a master computer and a plurality of slave computers. The control system generates bitmap image data which are stored in the control. The master computer generates the bitmap image data and outputs them to the slave computers. Each slave computer is connected to one of the display panels by way of a signal cable. An internal control portion of each display panel receives the image data by way of the connected signal cables to actuate the individual light-emitting elements accordingly.

A disadvantage with the previously known actuating system is that, in the construction of the display panels, each of those display panels has to be connected to a slave computer of the control by way of a special data cable. With a large number of display panels, a corresponding number of cables has to be laid. Conventionally, what are referred to as multicore cables are connected to the actuating system. A multicore cable conventionally includes up to 72 individual data lines. The connection of each individual data line to the corresponding display panel is a laborious and time-consuming operation.

Therefore the object of the present invention is to provide a display system which can be easily and quickly constructed.

That object is attained by the display system of claim 1. The display system according to the invention has a large number of display panels which each have a large number of light-emitting elements. The display system further includes a system control for actuation of the display panels. A single data bus connects the system control to each of the display panels.

A data bus is a subsystem of a computer architecture, which exchanges data between various bus subscribers. The system control and the display panels are each bus subscribers. By definition there is a data bus precisely when the flow of data is from a bus subscriber to all other bus subscribers. If a bus subscriber outputs data on to the data bus, those data go to all bus subscribers. Unlike the situation with a conventional connection, a bus can communicate a plurality of apparatuses with each other by way of the same set of lines. A data bus can be physically set up by all bus subscribers being connected to an individual cable by way of what are referred to as T-connectors. That situation involves what is referred to as a bus topology. The bus subscribers however can also be connected together as links in a chain. The flow of data goes then from a chain link (bus subscriber) to the next bus subscriber. In that case also the data go to each bus subscriber, and for that reason the situation also involves a data bus.

The advantage of the data bus lies in the simple cabling of the bus subscribers. The cabling requirement of the data bus is less than in the case of conventional cabling in which all display systems are connected in a star configuration to the system control. In addition it is easier to connect further bus subscribers to the display system. The display system can be easily expanded by further display modules. In that case the display modules are only connected to the data bus.

Preferably twisted pair cables, in particular Cat 5 cables are used for cabling of the individual bus subscribers. In computer technology the term twisted pair cable is used to identify types of cables in which the two wires of a pair of wires are twisted together (also stranded or braided). Data transfer is less susceptible to trouble due to the twisting of the respective outgoing line with the return line of a current loop (the pair of wires).

The Cat 5 cable is a particular twisted pair cable used for signal transmission with high data transfer rates. The specific standard identification is EIA/TIA-568. Because of the high signal frequencies operation must be particularly carefully implemented in the laying and assembly procedures, particularly at the connecting locations of the wires, and the manufacturing specifications have to be observed. Category 5 cables are frequently used in the structured cabling of computer networks such as for example Ethernet. The Cat 5e cable is an enhanced version of Cat 5 for use in 1000BASE-T-networks or for long-distance 100BASE-T-network connections (350 m, compared to 100 m for Cat 5). It must comply with the specification of EIA/TIA-568A-5 which however in the meantime has been superseded by the specification EIA/TIA-568B.

Preferably the system control is used as the bus master and the display panels each function as bus slaves of the data bus. The components connected to a bus are also referred to as nodes or bus subscribers. Nodes which may independently access the bus are referred to as active nodes or masters, otherwise they are referred to as passive nodes or slaves. A plurality of bus subscribers cannot simultaneously access the bus because for example a plurality of data packets which are transmitted at the same time interfere with each other and cause mutual disturbance. A bus which allows a plurality of master nodes is referred to as a multimaster bus. With multimaster buses, bus access has to be controlled by a specific component which is referred to as the bus arbiter. That node which initiates an access to the bus is referred to as the initiator while the aim of such (reading or writing) access is referred to as the target. Such a structure is considerably more complicated and expensive as additional components like the arbiter are required. As there is generally no need for the display panels to automatically transmit items of information to the system control, the system control can be set up as the sole bus master. The display system is thus less expensive and simpler to operate.

Preferably the system control is adapted to transmit data serially in the form of data packets by way of the data bus to a predetermined display panel. In serial data transmission data are transmitted in succession by way of a given medium, here the bus line. So that the data go to the predetermined display panel, each data packet contains a receiver address for the predetermined display panel. Precisely one address is allocated to each display panel in the bus system. The display panels are then adapted to recognise on the basis of the receiver address whether the data packet is addressed to the display panel in question. The system control passes the data packet to the data bus. The data packet automatically goes by way of the data bus to each connected display panel. The display panels decide on the basis of the receiver address whether they process or reject the data packet.

The display system according to the invention preferably includes a plurality of system controls which can each be connected by way of a dedicated data bus to a predetermined number of display panels. The finite data transmission capacity of the data bus means that the number of connected display panels is limited so that moving images can be represented in a high state of resolution on the display panels. Preferably display panels which are made up from 256 RGB pixels are used.

The display system is for example of such a design configuration that a maximum of 12 display panels can be connected to a system control by way of a data bus. Further display panels can be managed by the display system only when further system controls are provided. Preferably the arrangement has a synchronisation device for the synchronisation of the system controls. The system controls have to be synchronised if the time succession of images or video sequences on the display panels is to be fixed. The system controls each have so-to-speak a respective clock. Each of the clocks is synchronised when it displays the same time at each moment in time. Synchronisation can be effected for example by the system controls receiving the same clock signal.

The system control preferably includes a representation of a positioning and orientation of the display panels in a co-ordinate system. That representation is also referred to as a virtual screen. The large number of display panels connected to the system control generally forms a continuous unitary screen surface for a viewer when viewed from a distance. The endeavour is therefore to display overall a single interconnected continuous image on the display panels. For that purpose the system control receives all items of information relating to the position and orientation of the display panels. Those items of information are preferably put into a two-dimensional co-ordinate system.

For any image represented in the co-ordinate system, corresponding items of image information in respect of each display panel can be calculated on the basis of the respective positioning and orientation. All items of image information which are in the region of a display panel in the co-ordinate system have to be represented by the corresponding pixels of the display panel. The system control associates the individual pixels with the different display panels. In particular the system control determines which light-emitting elements of the display panel have to reproduce the items of image information.

Each display panel preferably includes a dedicated internal signal processing device. In that way each display panel can be connected by means of conventional twisted pair cables in series to another display panel with any desired line length.

Each display panel preferably has light-emitting elements in the form of LEDs (light-emitting diodes) and drivers for driving the LEDs. The drivers and the LEDs are preferably arranged on a printed circuit board and disposed with the board in a transparent tube. The display panel has a plurality of tubes arranged in a row with each other, in each of which is respectively disposed a board with the driver and the LEDs. A digital signal is passed to each driver. As signal processing is effected by the driver the display tubes, in a fixed installation, can be disposed at any distance from the frame of the display panel. The display tubes are usually actuated jointly from a frame in which the internal signal processing device is disposed.

The heat generated by the LED drivers is preferably dissipated by a special ventilation device. The ventilation device produces an air flow through the tube, which passes the heat generated by the electronic drivers to the ambient air. The tube is open at both ends. A ventilator or fan produces the air flow at an open end of the tube. In that case the heated air is transported away within the tube and replaced by cool ambient air.

Preferably the display system according to the invention includes connecting means which are adapted to releasably secure the display panels to each other and to connect the display panels in series with each other. The connecting means are therefore on the one hand plug connectors which provide for data to be passed through the data bus. In addition the connecting means provides for mechanically securing the display panels to each other. Thus a larger display panel can be easily built up from a plurality of display panels, by the display panels being fixed to each other by means of the connecting means. Furthermore, standardised connecting means permit a modular structure for the display system so that an existing group of display panels can be easily enlarged in a simple fashion by a further display panel.

The invention provides a display system which:
is transparent and can thus be integrated into the background,
is of a modular structure but nonetheless requires little visible image area for the frame,
is extremely light so that it can be assembled by only one engineer but is sufficiently stable to be transportable and withstands being repeatedly assembled and dismantled,
is quick and easy to assemble, by virtue of a self-locking plug-in system,
is quick and easy to assemble by virtue of using only one RJ45-cable Cat 5 for data transmission,
can be quickly assembled to afford systems of any size,
is flexible in construction in order to bridge over even relatively large spacings between the modules,
can be used in mobile fashion during operation,
can be used indoors and outdoors temporarily and also stationarily, and
has a high luminosity in respect of the LEDs with at the same time a large emission angle so that an image which remains of the same brightness appears in all viewing directions.

Preferred embodiments by way of example of the present invention are described hereinafter with reference to the accompanying Figures in which:

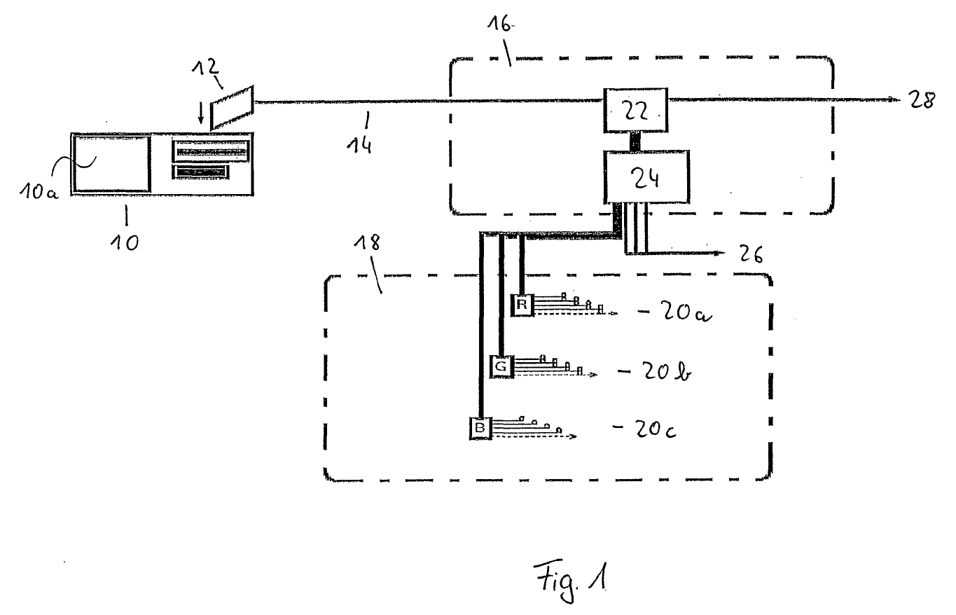

FIG. 1 shows a diagrammatic view of an embodiment of the display system according to the invention,

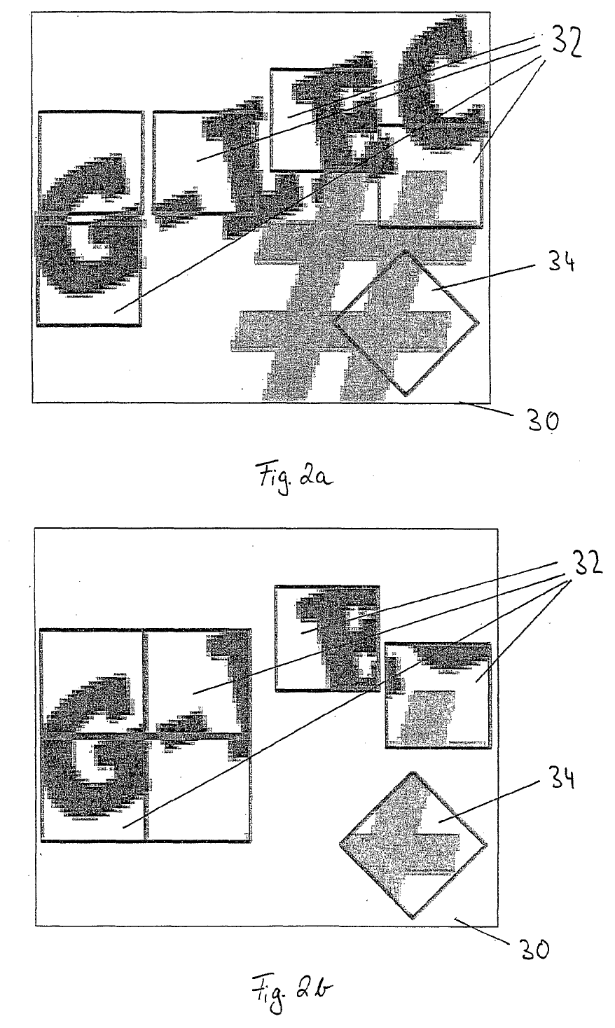

FIG. 2a shows an embodiment of a virtual screen with virtual image and virtual display panels,

FIG. 2b shows the virtual screen of FIG. 2a, in which the virtual image is shown only in the region of the display panels,

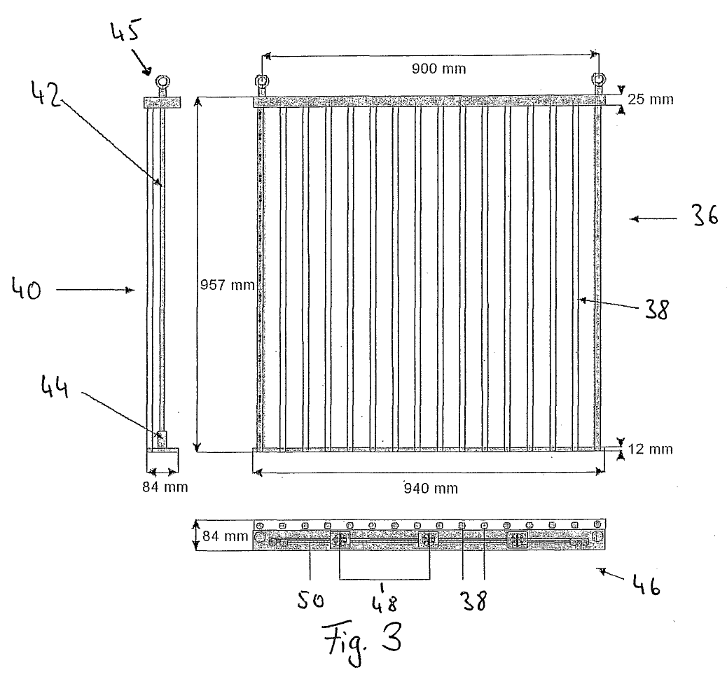

FIG. 3 shows a diagrammatic view of an embodiment of the display system according to the invention,

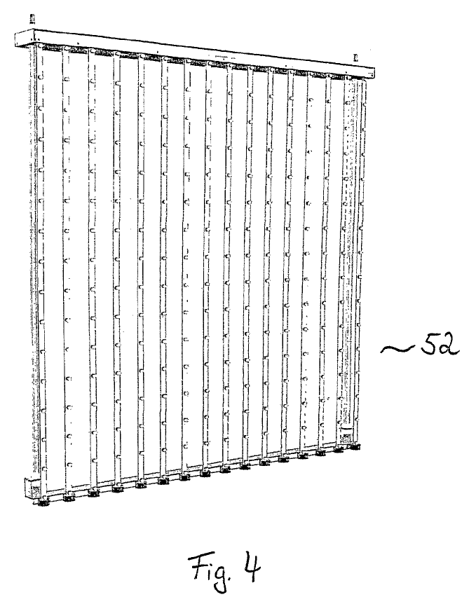

FIG. 4 shows a perspective view of the display panel of FIG. 3,

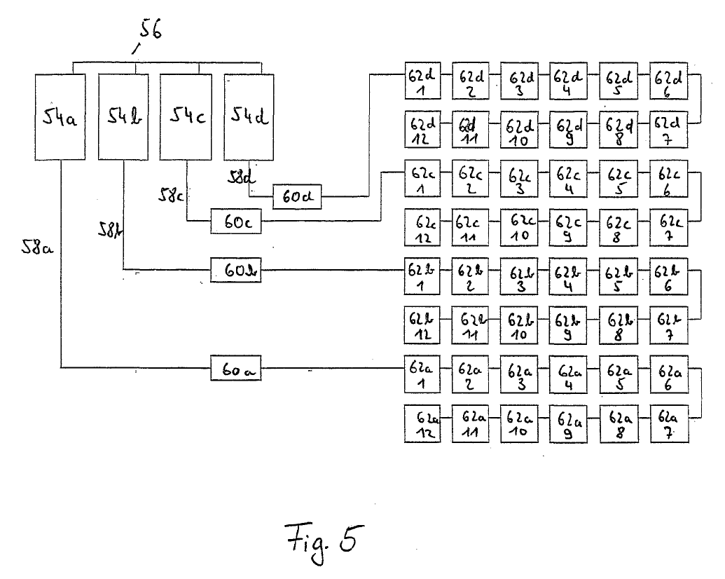

FIG. 5 shows a diagrammatic view of a block circuit diagram of the embodiment of the display system according to the invention,

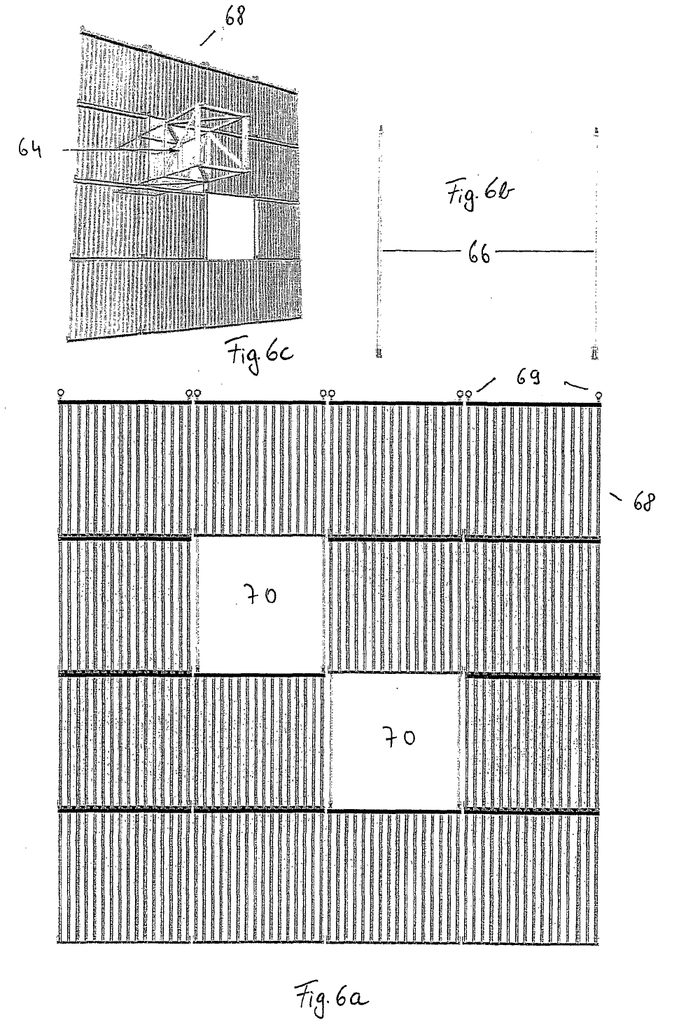

FIG. 6a shows an embodiment of an arrangement of the display panels according to the invention,

FIG. 6b shows two connecting shafts for connecting two display panels according to the invention,

FIG. 6c shows a perspective view of an embodiment of an arrangement of the display panels according to the invention,

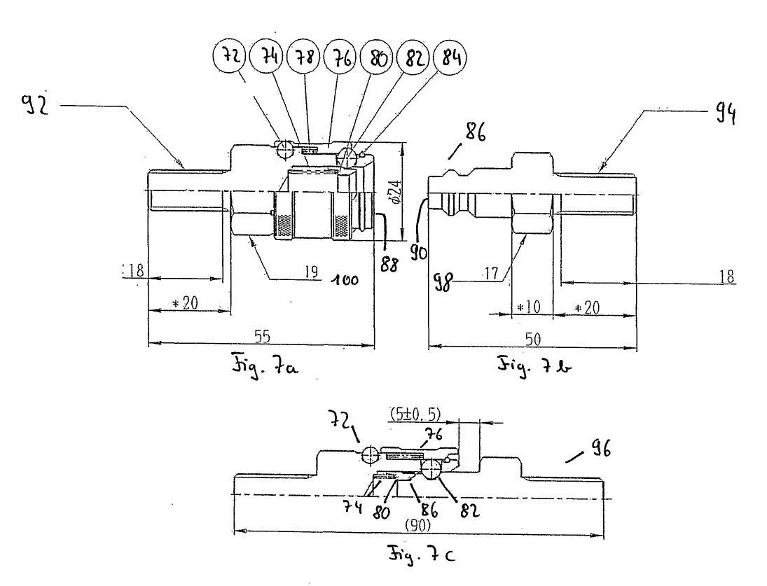

FIG. 7a shows a socket of a first embodiment of a connecting means according to the invention,

FIG. 7b shows a plug of a first embodiment of the connecting means according to the invention,

FIG. 7c shows the socket of FIG. 7a and the plug of 7b in the assembled condition,

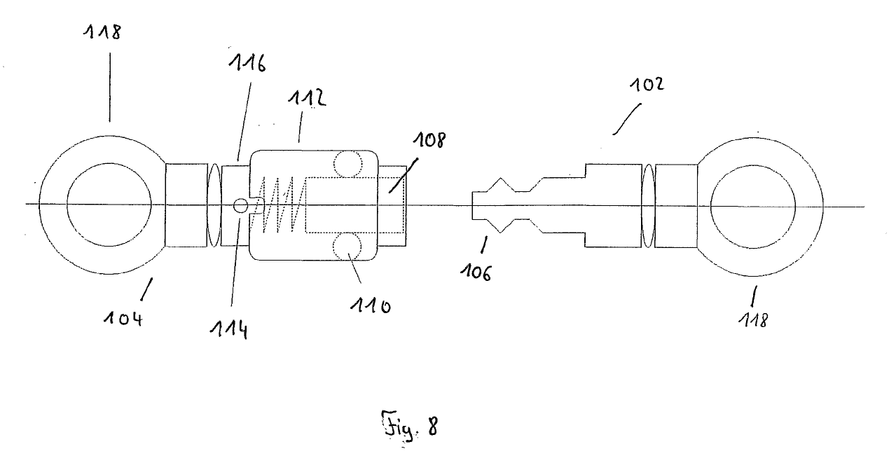

FIG. 8 shows a diagrammatic view of a second embodiment of the connecting means according to the invention,

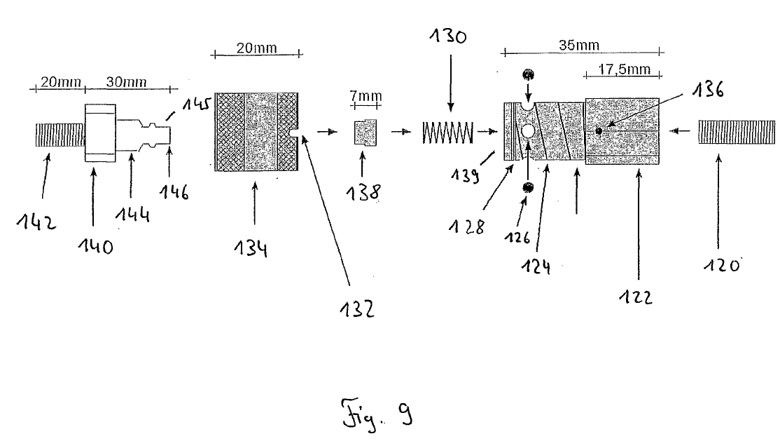

FIG. 9 shows an exploded view of the connecting means according to the invention,

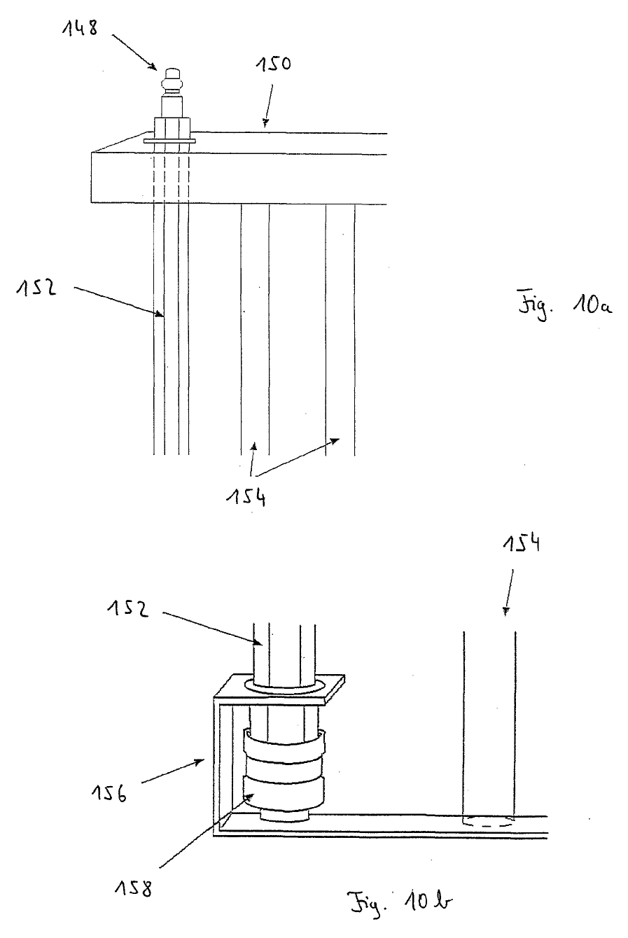

FIG. 10a shows an upper portion of the display panel according to the invention,

FIG. 10b shows a lower portion of the display panel according to the invention,

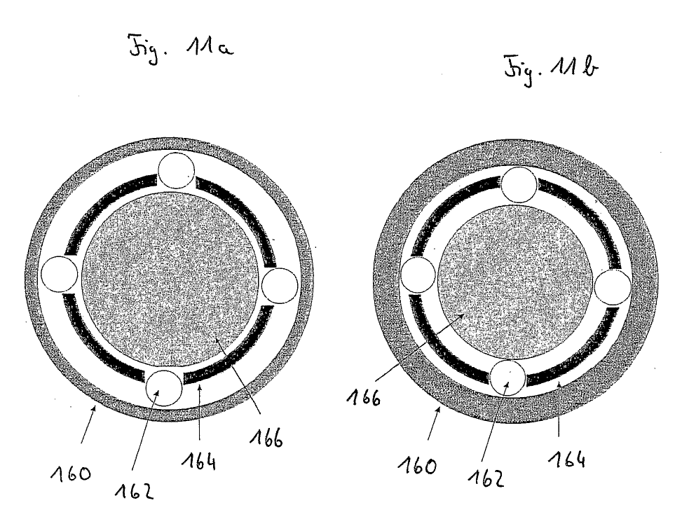

FIG. 11a shows a cross-sectional view of the connecting means according to the invention in the open condition,

FIG. 11b shows a cross-sectional view of the connecting means according to the invention in the closed condition, and

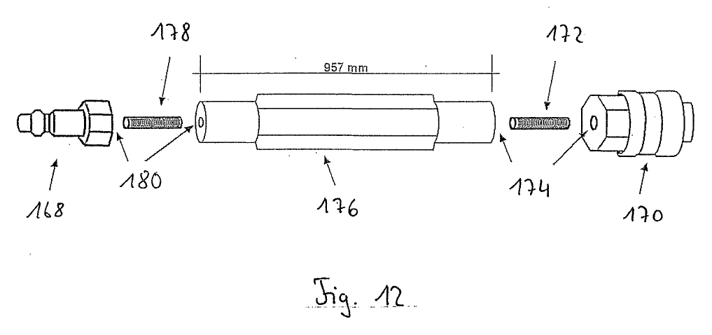

FIG. 12 shows an exploded view of a connecting bar for connecting the display panels according to the invention.

FIG. 1 diagrammatically shows an embodiment of the display system according to the invention. The display system includes a personal computer 10 which serves to control the display panels. The personal computer 10 has a graphics card. The computations for generating the image data for the display system are effected by means of the graphics card. The graphics card has a chipset which is specialised for performing graphics computations and which on the one hand accelerates the computations and on the other hand relieves the load on the processor. Connected to an interface card 12 is a Cat 5 cable 14 which functions as a bus line. A display panel in FIG. 1 includes an upper frame 16 and a lower frame. The bus line 14 connects the upper frame 16 of the display panel to the interface card 12 of the personal computer 10.

The upper frame portion 16 of the display panel comprises an aluminum housing in which all of the control electronics are disposed. A communication unit 22 and a CPU 24, that is to say a central processing unit, are constituent parts of the control electronics of the display panel. The display panel accordingly has an independent computing unit which for example could at least partially take over computation of the control signals for the graphic representation of the display panel, from the graphics card 12. The communication unit 22 and the CPU however are predominantly provided to permit data exchange between the system control 12 and the other (not shown) display panels by way of the data bus, wherein the communication unit 22 receives the data packets passing by way of the data bus and puts them into intermediate storage. A further bus line 28 is provided, which connects the illustrated display panel to the next display panel which is not illustrated here.

The CPU, on the basis of the address fields of the received data packets, ascertains whether they are intended for the illustrated display panel. Each display panel and the system control have a unique address in the data bus. The bus data are transmitted serially, that is to say in succession, by way of the bus lines. Each data packet includes an address field specifying the address of the display panel to which the data packet is to pass. If the CPU 24 recognises that the address in the address field is in conformity with the address of its own display panel the received data packet is subjected to further processing. Otherwise the data packet is forwarded to the next display panel by way of the bus line 28.

The display system is of a modular structure, wherein each display panel comprises for example 256 RGB pixels which are arranged in a two-dimensional raster of 60 mm. The display panels represent the modules of the display system. By virtue of the two-dimensional raster, intermediate spaces are formed, which are used for transparent image generation on stages of theaters or in architecture.

Sixteen transparent polycarbonate tubes are fixedly connected at spacings of 60 mm to the frame of the display panel. One of those tubes 18 is diagrammatically shown in FIG. 1. Disposed in each of those tubes is a long narrow circuit board on which a total of sixteen light dots are distributed at a spacing of 60 mm. Each light dot consists of precisely one red, one green and one blue light-emitting diode (LED). In FIG. 1 the red-lighting LEDs are identified by reference 20a, the green-lighting LEDs are identified by reference 20b and the blue-lighting LEDs are identified by 20c. Also disposed on that circuit board are the driver ICs for the LEDs. The abbreviation IC stands for integrated circuit. Consequently the drivers are also embodied in the form of a circuit arrangement on the board. The CPU processes the image data received by way of the bus line 16 and outputs them in suitable form to the corresponding driver ICs.

At least one respective LED in the colors red, green and blue is used as the light-emitting means. Manufacturers are for example Digital Light, Nichia or Everlight. The LEDs light up in the primary colors which by virtue of their specific selection permit any color mixing in the color spectrum. The same effect can be achieved by the use of RGB-LEDs. These are LEDs with three different crystals in a housing. It is also possible to use SMD-LEDs. When selecting the LEDs, attention is to be paid to a large radiation angle of at least 70° with at the same time a high level of light intensity. In addition LEDs of the highest color and intensity selection step are used to avoid color and brightness differences. Color and brightness differences are visible precisely in relation to particularly large systems composed of many individual modules.

Regulation of the brightness of an LED can be effected by regulating the current through the LED or by pulse width modulation (PWM).

In brightness regulation by virtue of varying the current through the LED, the color shade of the LED changes. In addition the brightness cannot be continuously reduced down to zero as each LED needs a minimum current for lighting up.

Therefore pulse width modulation (PWM) is preferred for regulating the brightness of the LEDs. That means that the LED is always operated with a 100% brightness. Regulation is effected by periodically switching the LED on and off. The shorter period of time for which the LED is switched on during a unit of time, the correspondingly lower is the level of brightness. In order to avoid visible flickering of the LED in the camera image, the pulse is subdivided and individual or partial pulses are distributed uniformly over the duration of the original time window of the 100% pulse. In that case the duration of the individual pulses is correspondingly shortened so that the area of the individual pulses (energy) remains of the same magnitude, that is to say equal to the 100% output pulse.

FIG. 2a shows an embodiment of a virtual screen 30 with a virtual image and virtual display panels 32 and 34. The virtual screen 30 could be represented for example on a monitor 10a connected to the personal computer 10. Shown in the virtual screen 30 is an image which is intended to be displayed by the display panels 32 and 34 connected to the personal computer 10. A control software is installed on the personal computer 10. In what is referred to as the frame setup (virtual screen), a user can cause the image to be represented on the display panels 32, 34, to be displayed on the screen 10a of the PC 10.

The screen 30 reproduces true to scale the position and orientation of the actual display panels, wherein the representation of the virtual display panel 34 shows that the display panel corresponding to the virtual display panel 34 is rotated. The image represented in front of or with the virtual display panels 32, in FIG. 2a, graphically represents the text ‘G-LEC #’. FIG. 2b again shows the virtual screen. In this case however, only those regions of the text which are on one of the virtual display panels 32 and 34 are shown. The virtual screen 30 in FIG. 2b therefore reproduces true to scale, how the text ‘G-LEC’ would be represented by the display panels which are actually connected.

The display system described herein serves for the representation of animations, images or videos in real time. For that purpose any NTSC signal or DMX512/1990 can be used for that purpose. Any data file format can be processed for the representation of images. Played live videos, images and animations can be represented in combination by means of 2-layer technology in 24 bit full color RGB.

FIG. 3 shows a diagrammatic view of an embodiment of a display panel according to the invention. The display panel is shown on the one hand in a front view 38, a side view 40 and a plan view or a view from below 46. The display panel in FIG. 3 includes tubes which are made from polycarbonate. The lower open end of those polycarbonate tubes is fixed in position with an aluminum rail. Fans or ventilators 48 installed in the underside of the display panel cause air to flow through the tubes 38, whereby the LED drivers and the electronics of the display panel are cooled.

Fans 48 are supplied with power by way of electrical conductors 50. Two bars form the lateral frame 42 of the display panel and connect an upwardly disposed housing to a downwardly disposed aluminum rail. That forms a stable display module which is independent in itself. Disposed at the lower end of each connecting bar is a quick-action fastener 44. The counterpart portion 45 matching the quick-action fastener 44 is disposed at the upper end of the lateral frame 42. FIG. 4 shows a perspective view of the display panel 52.

FIG. 5 shows a diagrammatic view of a block circuit diagram of the embodiment of the display system according to the invention. The display system includes a plurality of system controls 54a, 54b, 54c and 54d in the form of personal computers. Each of the system controls 54a, 54b, 54c and 54d is connected by way of corresponding data lines 58a, 58b, 58c and 58d and mains units 60a, 60b, 60c and 60d for power supply to precisely 12 display panels. The display panels 62a-1 through 62a-12 are associated with the system control 54a; the display panels 62b-1 through 62b-12 are associated with the system control 54b; the display panels 62c-1 through 62c-12 are associated with the system control 54c; the display panels 62d-1 through 62d-12 are associated with the system control 54d. The individual system controls 54a through 54d are synchronised with each other by way of a line 56. Twelve respective display panels are actuated with a system control.

Data transmission between PC and display panel is effected with a single RJ45-cable Cat 5. All further display panels are also connected together with a RJ45 cable. Any number of displays are connected together to afford a large system, in which case a dedicated system control is required for each twelve modules. All PCs are synchronised with a sync box in order to avoid different signal transit times. The sync box outputs a clock-controlled signal by way of the line 56 to each of the system controls 54a, 54b, 54c and 54d. The system controls have to be synchronised with each other so that actuation of the different display panels can be correlated with each other in respect of time.

FIG. 6a shows an embodiment of an arrangement of the display panels according to the invention. To produce larger display areas, the individual display panels 68 are pluggingly connected to each other. Reference 70 identifies two openings in the illustrated display panel arrangement. The individual display panels, except for the openings 70, form a rectangular display area. FIG. 6c shows the display panel arrangement, as to how it could be fixed to a wall. A support structure 64 is mounted in each of the openings 70. In order to be able to suspend the display system, respective eye nuts 69 are fitted on to the uppermost display panels.

FIG. 6b shows two connecting bars 66 for the connection of two display panels according to the invention. In a horizontal mounting arrangement or when a turned structure is involved, an eye nut can also be fitted on to the quick-action coupling of the lower end of the connecting bar. In order to produce the openings 70 upon construction, the connecting bars 66 can also be fitted individually. For horizontally connecting individual display panels 68, thin plates can be inserted between a quick-action coupling and a counterpart portion. Each display panel is of an identical structure and is operational on its own. Display areas of any kind can be constructed in that way.

FIG. 7a shows a socket 92. The connecting means according to the invention is a plug connection, wherein the constituent part shown in FIG. 7a is provided to receive a plug pin 90. The socket 92 has a plug receiving means 88. The plug 94 shown in FIG. 7b has a plug pin 90 which is provided for being inserted into the plug receiving means 88, thereby forming a plug connection between the plug 94 and the plug socket 92. The plug 94 further includes a hexagonal external portion 98 which can be rotated by means of a suitable wrench. The socket has a series of features which serve to arrest the inserted plug pin 90: in particular the socket 92 includes a holding ring and an arresting ball 82. The pin 90 in turn has an annular projection 86.

FIG. 7c shows the socket and the plug in the assembled condition. The pin 90 is fitted into the plug receiving means and the arresting ball 82 is disposed behind the projection 86. In that way the arresting ball prevents the pin 90 from being able to come out of the plug receiving means 88 again of its own accord. A sleeve 76 is disposed above the arresting ball and provides that the arresting ball 82 is pressed on to the pin 90. The sleeve is mounted movably in the longitudinal direction along the socket 92. A spring 74 provides that the sleeve 76 is over the arresting ball. In addition the sleeve is held in its position by a holding ring 84.

To release the plug connection the sleeve 76 is pushed against the spring force of the spring 74 rearwardly away from the plug receiving means until the sleeve is held in a pushed-back position as shown in FIG. 7a, by an arresting ball 72. The arresting ball 82 can now be moved in a radial direction away from the plug receiving means. As a result, the arresting action in respect of the plug pin 90 is released for the arresting ball no longer engages behind the annular projection 86. Within the receiving means 88 there is a slider 80 which is biased by a further spring 74. By means of the spring force, the slider 80 pushes the plug pin 90 out of the receiving means.

FIG. 8 shows a diagrammatic view of a further embodiment of the connecting means according to the invention. This again involves a plug connection. The plug 102 has a plug pin with an annular projection. A socket 104 has a plug receiving means 108. Arranged within the plug receiving means are securing balls 110 which are provided for arresting the plug pin 106 in the plug receiving means. The socket 104 additionally includes a sleeve 11 which is movable in the longitudinal direction and which can be arrested by means of a securing ball 114. At the end opposite to the plug receiving means, the socket 104 has an eye nut. The plug 102 also has an annular socket 118 which is on the side opposite to the plug pin 106.

FIG. 9 shows an exploded view of the connecting means of FIG. 8. The plug includes a screwthreaded bar 142, an external hexagonal portion 140 and a screwthreaded pin 145 with a radial projection. The screwthreaded pin 145 has a tip 146 which is substantially cylindrical and is 8 mm in diameter. The plug pin 145 also has a shoulder 144, the cross-section of which is 12 mm in diameter. The hexagonal portion 140 is about 17 mm in diameter.

The socket of the plug connection has an unlocking sleeve 134 of a diameter of 24 mm in cross-section. The unlocking sleeve 134 has a securing groove 132. The socket further has a securing ball 136 intended to engage into the securing groove so that the securing sleeve is arrested on the socket. The socket further has a locking bolt member or a slider 138 disposed within a plug receiving means 139. The locking bolt member is biased by a spring 130 when the plug pin is disposed in the receiving means.

The assembly also has two arresting balls 126 which hold the plug pin 145 fixed in position in the receiving means 139, by engaging behind the annular projection on the plug pin 145. The securing sleeve 134 is fitted over the plug receiving means 139 in the closed condition. An external coil spring 124 is biased and urges the sleeve 134 against a securing ring 128. The socket has an external hexagonal portion 122 so that it can be turned with a suitable wrench. It is fixed by means of a screwthreaded bar to the display panels.

FIG. 10a shows an upper portion of the display panel according to the invention. The display panel includes an electronics housing 150 in which a communication unit and a central processing unit are disposed. They are connected to further display panels by way of a bus line. For that purpose a plug connection 148 is provided in the upper region of the display panel. In particular the Figure shows the plug pin 148 which is provided to be introduced into a corresponding receiving means.

The plug connection provides not only for mechanically holding the display panels together. The plug pin therefore also serves to provide an electrical connection. Also shown is a connecting bar 152 which has an external surface in the form of a hexagon. The connecting bar 152 forms the lateral end of the display panel. Display tubes 154 are arranged parallel to the connecting bar. Disposed within the display tubes are the LEDs in the three primary colors red, green and blue, which are actuated by the CPU within the electronics housing.

FIG. 10b shows a lower portion of the display panel according to the invention. Once again the connecting bar 152 of FIG. 10a and an adjoining display panel 154 are illustrated here. In contrast to FIG. 10a no electronics housing 150 is disposed in the lower region of the display panel. The display tubes are held fast in mutually parallel relationship by a simple rail. In addition, there is no plug pin in the lower region of the connecting bar 152 but the lower frame 156 reinforces the fixing of the connecting bar which at the lower end has the counterpart portion in relation to the plug pin—the socket 158.

FIG. 11a shows a cross-sectional view of the connecting means according to the invention in the open condition. A plug pin 166 and an unlocking socket 160 are each shown in cross-section. The Figure also shows four securing balls 162 within the plug receiving means 164 of the socket 160. FIG. 11b shows a cross-sectional view of the connecting means of FIG. 10a in the closed condition. The illustrated cross-section of the plug pin is narrowed, in contrast to the cross-section shown in FIG. 11a. For, in FIG. 11a, the annular radial projection of the plug pin forms the region of the illustrated cross-section. By virtue of the narrowed cross-section in FIG. 10b the securing balls 162 are urged through radial holes in the plug receiving means 164 and engage behind the securing ring of the plug pin. The pin is thus arrested within the receiving means.

FIG. 12 shows an exploded view of a connecting bar for connecting the display panels according to the invention. The connecting bar centrally has an internal bar 176 which is 957 mm long and the external cross-section of which is the same as that of a hexagon. The internal bar 176 is screwed by means of a screwthreaded bar to a socket 170 of a plug connection according to the invention. For that purpose female screwthreads 174 are provided within the internal bar 176 and the socket 170 respectively. In just the same way a plug 168 of a connecting means according to the invention is fixed to the opposite end of the internal bar 176. A screwthreaded pin 178 is screwed into female screwthreads provided in the internal bar 176 and in the plug 168.

### LIST OF REFERENCES

10 personal computer
12 graphics card
14 data bus (Cat 5 cable)
16 upper frame of the display panel
18 LED tube 1
20a red LEDs
20b green LEDs
20c blue LEDs
22 communication unit of the display panel 16
24 CPU of the display panel 16
26 connections for LED tubes 2 through 16
28 bus line to the next display panel
30 virtual screen
32 display panels in the virtual screen 30
34 display panel (turned through 45°) in the virtual screen 30
36 display panel
38 LED tube of the display panel 36
40 side view of the display panel 36
42 lateral frame of the display panel 36
44 quick-action fastener
45 counterpart portion of the quick-action fastener 44
46 top view of the display panel 36
48 fans of the display panel 36
50 conductors of the display panel 36
52 perspective view of a display panel
54a personal computer
54b personal computer
54c personal computer
54d personal computer
56 synchronisation of the personal computers 54a, 54b, 54c and 54d
58a data line
58b data line
58c data line
58d data line
60a mains unit
60b mains unit
60c mains unit
60d mains unit
62a bus line and 48V power line
62b bus line and 48V power line
62c bus line and 48V power line
62d bus line and 48V power line
62a-1 through 62a-12 display panels associated with PC 54a
62b-1 through 62b-12 display panels associated with PC 54b
62c-1 through 62c-12 display panels associated with PC 54c
62d-1 through 62d-12 display panels associated with PC 54d
64 support structure
66 connecting bars
68 arrangement of display panels
69 eye nuts
70 opening in the display panel arrangement 68
72 ball
74 spring
76 sleeve
78 sleeve spring
80 cuff
82 ball
84 holding ring
86 annular projection
88 plug receiving means
90 plug pin
92 socket
94 plug
96 plug connection
98 external hexagonal portion
100 external hexagonal portion
102 plug
104 socket
106 plug pin
108 plug receiving means
110 securing ball
112 sleeve
114 securing ball
116 hexagonal portion
118 eye nut
120 screwthreaded bar
122 hexagonal portion
124 external spiral spring
126 securing ball
128 securing ring
130 internal spiral spring
132 securing groove
134 unlocking sleeve
136 securing ball for socket
138 locking bolt member
140 hexagonal portion
142 screwthreaded bar
144 shoulder on the plug pin
146 tip of the plug pin
148 plug of the quick-action fastener
150 electronics housing
152 hexagonal connecting bar
154 display tubes
156 lower frame of the display panel
158 socket of the quick-action fastener
160 unlocking sleeve
162 securing ball
164 plug receiving means
166 plug pin
168 plug of the quick-action fastener
170 socket of the quick-action fastener
172 screwthreaded bar
174 female screwthread
176 hexagonal connecting bar
178 screwthreaded bar
180 female screwthread

1-10. (canceled)

11. A display system comprising
a large number of display panels (32, 34, 36; 62a-1-62d-12), each having a large number of light-emitting diodes (38), and
a large number of self-locking plug connectors for releasably fixing the display panels to each other.

12. A display system as set forth in claim 11 wherein
the plug connector has a plug (94) and a socket (92) for receiving the plug (94),
wherein the socket has arresting means for arresting the plug (94).

13. A display system as set forth in claim 12 wherein
the arresting means have a holding ring and an arresting ball (82),
wherein the plug (94) has a pin with an annular projection (86) which when the plug is inserted into the socket co-operates in positively locking relationship with the arresting ball in such a way that a self-locking plug connection is produced.

14. A display system as set forth in claim 13 wherein
the socket has a sleeve (76) which is movable in the longitudinal direction of the socket and which is arranged in the region of the arresting ball (82) in such a way that the sleeve (76) urges the arresting ball behind the annular projection (86) when the plug is inserted into the socket,
wherein the sleeve (76) is movable in the longitudinal direction of the socket for releasing the plug connection.

15. A display system as set forth in claim 14 wherein
the socket has a spring for biasing the sleeve in an arresting position.

16. A display system as set forth in claim 14 or claim 15 wherein
the socket has a securing ball for arresting the sleeve, wherein the securing ball engages into a groove in the sleeve upon opening and the sleeve is rotated upon arresting in such a way that the securing ball cannot engage into the groove.

17. A display system comprising
a plurality of display panels (32, 34, 36; 62a-1-62d-12), each having a plurality of light-emitting diodes (38), and
a system control unit (10, 22) for determining a positioning and orientation of at least one of the display panels (32, 34, 36; 62a-1-62d-12) in a co-ordinate system and for computing items of image information for at least those display panels whose position and orientation have been determined for a virtual image which is represented in the co-ordinate system.

18. A display system as set forth in claim 17 wherein
the system control unit is adapted to select display panels whose position and orientation in the co-ordinate system is to be determined.
